(19) United States
(12) Patent Application Publication
(10) Pub. No.: US 2009/0097002 A1
(43) Pub. Date: Apr. 16, 2009

(54) EXPOSURE DEVICE

(75) Inventors: Takeshi Fukuda, Kanagawa (JP); Takashi Fukui, Kanagawa (JP); Yoji Okazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/917,276

(22) PCT Filed: Jun. 13, 2006
(86) PCT No.: PCT/JP2006/311843

§ 371 Date: Dec. 12, 2007

(30) Foreign Application Priority Data
Jun. 15, 2005 (JP) 2005-175391

(51) Int. Cl. G03B 27/42

(52) U.S. Cl. 355/53

(57) ABSTRACT

The present invention provides an inexpensive exposure device with a simple structure which can draw in high precision by correcting drawing pixel positions at a time of exposing by respective beams emitted from a side of a device for selectively modulating a plurality of pixels so as to draw. A predetermined drawing shape is obtained by relatively moving a stage and an exposure head so as to execute a scanning exposure in accordance with a predetermined pattern in a state of regulating an image allocated to each of drawing pixels on the basis of correcting data, stored in a memory of a control unit, at least relating to a locus of drawing pixel positions corresponding to scanning positions of predetermined drawing pixels necessary for correction, and radiating each of light beams emitted from a device disposed in the exposure head selectively modulating a plurality of drawing pixels on the basis of the adjusted image data on an exposure member mounted on the stage.

### TECHNICAL FIELD

The present invention relates to an exposure device exposing with a predetermined pattern by focusing and irradiating each of plural beams emitted from a device, such as a spatial light modulating element disposed in an exposure head, which selectively modulates a plurality of pixels one by one with an optical element such as a lens array or the like, on the basis of image data (pattern data).

### BACKGROUND ART

In recent years, a digital exposure device (multibeam exposure device) has been put to practical use, which executes an image exposure on an exposure member by a light beam modulated in correspondence with image data by utilizing a spatial light modulating element such as a digital micro mirror device (DMD) as a pattern generator.

The DMD is a mirror device in which plural micro mirrors, having reflection surfaces, the angles of which change according to control signals, are two-dimensionally arranged on a semiconductor substrate such as silicone or the like, and the DMD is configured such that the angle of the reflection surfaces of the micro mirrors may be changed by electrostatic force generated by electric charges stored in each of plural memory cells.

In conventional digital exposure devices using a DMD, an exposure head may be used, which collimates laser beams emitted from a light source that emits laser beams via a lens system, and reflects the laser beams respectively by the plural micro mirrors of the DMD, which are arranged at an approximate focal position of the lens system, so as to emit the respective beams from a plurality of beam emitting ports. Further, the respective beams emitted from the beam emitting ports of the exposure head may be imaged with small spot diameters on an exposure surface of a photosensitive material (an exposure member), by a lens system having an optical element such as a micro lens array which focuses the respective beams emitted at one lens per one pixel, and a high-resolution image exposure is executed.

In this digital exposure device, each of the micro mirrors of the DMD is controlled to be ON or OFF by a control device on the basis of control signals generated in correspondence with the image data or the like, so as to modulate (deflect) the laser beams, and the modulated laser beams are irradiated onto the exposure surface (recording surface) to execute the exposure.

In this digital exposure device, the photosensitive material having a photoresist layer serving as a drawn body is disposed on a drawing table which moves along a pair of guide rails, a plurality of exposure units are arranged above the drawing table, and the DMD of each of the exposure units is modulated in correspondence with the image data while the drawing table is moved so as to radiate the laser beams on the photosensitive material. Due to this, a scanning exposure process for relatively moving positions of beam spots with respect to the photosensitive material and performing a pattern exposure on the photosensitive material can be executed.

In this digital exposure device, when the exposure device is used, for example, in a scanning exposure process which exposes a circuit pattern on a substrate at a high precision, because the lens used in an illumination optical system or an imaging optical system of the exposure head has inherent strain characteristics known as distortion, a reflection surface formed by the micro mirrors of the DMD and a projected image on the exposure surface do not have an accurate similarity relation, and the projected image on the exposure surface is deformed due to the distortion, and displacements of drawing pixel positions may occur and the drawing pixel positions may not coincide exactly with the designed circuit pattern.

Accordingly, for conventional exposure devices, there has been proposed a means for correcting the distortion, wherein an original point is set at a predetermined position in an overall exposure region projected on a drawing surface by exposure units, a relative position (exposure point) of an optical image formed by a predetermined micro mirror is measured by a dedicated instrument before drawing, and this measured value is stored in advance as exposure point coordinate data in a ROM of a system control circuit. At the time of drawing, the actually measured value is output as the exposure point coordinate data to an exposure point coordinate data memory.

Accordingly, bit data of the circuit pattern, in which the distortion is substantially corrected, is held in the exposure data memory. Therefore, since the exposure data given to each of the micro mirrors include values obtained by taking the distortion into consideration, it is possible to draw the circuit pattern with high precision even if the optical element of the exposure unit has distortions (as an example, refer to patent document 1).

In this exposure device, or in conventional general exposure devices, when the drawing table is moved for executing the scanning exposure process, the drawing table moves tortuously. Accordingly, errors occur at the drawing pixel positions concomitant with the scanning exposure.

Therefore, in order to correct the errors that occur with the scanning exposure, the drawing table moving along the pair of the guide rails may be structured such that it moves on a straight line along a scanning direction, for example, by setting a micromotion adjustment operating means in the scanning direction, a micromotion adjustment operating means in a direction orthogonal to the scanning direction, and a micromotion adjustment operating means in a direction of rotating the drawing table, and simultaneously executing advanced control of these means by a control device.

However, in this exposure device, if the drawing table is provided with the micromotion adjustment operating means in the scanning direction, the micromotion adjustment operating means in the direction orthogonal to the scanning direction, the micromotion adjustment operating means in the direction of rotating the drawing table, and the control device for controlling these means, thereby correcting the errors concomitant with the scanning exposure, there is a problem that the exposure device is enlarged in size, and the structure becomes complicated and expensive.

Patent Document 1: Japanese Patent Application Laid-Open (JP-A) No. 2003-57834

### DISCLOSURE OF THE INVENTION

### Problem To Be Solved By The Invention

In view of the aforementioned problems, an object of the present invention is to newly provide an inexpensive exposure device with a simple structure, which can draw with high precision by correcting drawing pixel positions at a time of exposing and drawing by respective beams emitted from a side of a device for selectively modulating a plurality of pixels.

### Means For Solving The Problem

In accordance with a first aspect of the present invention, there is provided an exposure device for executing an exposure with a predetermined pattern by relatively moving a stage and an exposure head, in a state where respective light beams emitted from a device for selectively modulating a plurality of drawing pixels disposed in the exposure head on the basis of image data are radiated on an exposure member mounted on the stage, the exposure device comprising a control unit which stores correcting data relating to a locus of drawing pixel positions corresponding to scanning positions of predetermined drawing pixels at least necessary for correction in a memory, and a drawing position correcting portion which obtains a predetermined drawing shape by adjusting an image which is allocated to each of the drawing pixels on the basis of the correcting data stored in the control unit.

In accordance with a second aspect of the invention, there is provided an exposure device for executing an exposure with a predetermined pattern by relatively moving a stage and an exposure head in a state where respective light beams emitted from a device for selectively modulating a plurality of drawing pixels disposed in the exposure head on the basis of image data are irradiated on an exposure member mounted on the stage, the exposure device comprises a beam position detecting portion which detects a position of a predetermined drawing pixel at least necessary for correction, which is irradiated on the exposure member on the stage from the exposure head, a moving position detecting portion which detects a relative positional relation between the stage and the exposure head when the stage and the exposure head are moved relatively, a control unit which stores correcting data relating to a locus of drawing pixel positions in correspondence with scanning positions of the predetermined drawing pixels at least necessary for correction, which is obtained from detected data by the beam position detecting portion and detected data by the moving position detecting portion, in a memory, and a drawing position correcting portion which obtains a predetermined drawing shape by adjusting an image which is allocated to each of the drawing pixels on the basis of the correcting date stored in the control unit.

In accordance with a third aspect of the invention, there is provided an exposure device for executing an exposure with a predetermined pattern by relatively moving a stage and an exposure head in a state where respective light beams emitted from a device for selectively modulating a plurality of drawing pixels disposed in the exposure head on the basis of image data are irradiated on an exposure member mounted on the stage, the exposure device comprises a beam position detecting portion which detects a position of a predetermined drawing pixel at least necessary for correction, which is irradiated on the exposure member on the stage from the exposure head, and determines a single drawing strain state within an exposure area, a moving position detecting portion which detects vector data at a time of relatively scanning and moving the stage and the exposure head, a control unit which stores correcting data relating to a locus of drawing pixel positions in correspondence with scanning positions of the predetermined drawing pixels at least necessary for correction, which is obtained from the single strain state by the beam position detecting portion and the vector data during scanning and moving detected by the position detecting portion, in a memory, and a drawing position correcting portion which obtains a predetermined drawing shape by adjusting an image which is allocated to each of the drawing pixels on the basis of the correcting date stored in the control unit.

In accordance with the above-described structure, it is possible to correct the drawing pixel position at a time of exposing and drawing by the respective beams emitted from the side of the device for selectively modulating a plurality of pixels, and execute the drawing high-precisely so as to form an exposed image having a high quality, by adjusting the image allocated to each of the drawing pixels due to the drawing position correcting portion, on the basis of the correcting data, which is stored in the memory of the control unit, relating to the locus of the drawing pixel positions in correspondence with the scanning positions of the predetermined drawing pixels at least necessary for the correction. Further, it is possible to obtain an inexpensive exposure device with a simple structure, without using a device wherein the structure thereof for finely moving and controlling the relative position between the moving stage and the exposure head in order to correct the drawing pixel position is complicated and expensive.

In accordance with a fourth aspect of the present invention, there is provided an exposure device for executing an exposure with a predetermined pattern by relatively moving a stage and an exposure head in a state where respective light beams emitted from a device for selectively modulating a plurality of drawing pixels disposed in the exposure head on the basis of image data are irradiated on an exposure member mounted on the stage, the exposure device comprises a control unit which forms an image obtained by drawing a locus of each of the drawing pixel positions by relatively moving and scanning the stage and the exposure head in a state where a drawn medium is mounted on the stage and the pixels are exposed by a predetermined plurality of exposure beams which are lighted as representative points in an exposure area of the exposure head, measures the locus of each of the drawing pixel positions drawn on the drawn medium and determines locus data of each of the drawing pixel positions in correspondence with scanning positions, and stores the determined locus data of each of the drawing pixel positions in correspondence with the scanning positions in a memory, and a drawing position correcting portion which obtains a predetermined drawing shape by adjusting an image which is allocated to each of the drawing pixels on the basis of the locus data stored in the control unit.

In accordance with the above-described structure, since the locus of each of the drawing pixel positions drawn on the exposure member is measures and the locus data of each of the drawing pixel positions in correspondence with the scanning positions is determined, the exposure device is not necessary to be provided with a structure for determining the locus data of each of the drawing pixel positions. Accordingly, it is possible to simplify the structure of the exposure device itself. Further, it is possible to correct the drawing pixel position at a time of exposing and drawing by the respective beams emitted from the side of the device for selectively modulating a plurality of pixels, and execute the drawing high-precisely so as to form an exposed image having a high quality, by adjusting the image allocated to each of the drawing pixels due to the drawing position correcting portion, on the basis of the correcting data, which are stored in the memory of the control unit, relating to the locus of the drawing pixel positions in correspondence with the scanning positions of the predetermined drawing pixels at least necessary for the correction. Further, it is possible to obtain an inexpensive exposure device with a simple structure, without using a device wherein the structure thereof for finely moving and controlling the relative position between the moving stage and the exposure head in order to correct the drawing pixel position is complicated and expensive.

In accordance with a fifth aspect of the present invention, there is provided an exposure device for executing an exposure with a predetermined pattern by relatively moving a stage and an exposure head in a state where respective light beams emitted from a device for selectively modulating a plurality of drawing pixels disposed in the exposure head on the basis of image data are irradiated on an exposure member mounted on the stage, the exposure device comprises a control unit which measures a locus of each of the drawing pixel positions in correspondence with scanning positions by a measuring device of the drawing pixel position, by relatively moving and scanning the stage and the exposure head in a state where the measuring device of the drawing pixel position having a two-dimensional measurement area is mounted on the stage, and the pixels are exposed by a predetermined plurality of exposure beams which are lighted as representative points in an exposure area of the exposure head, and determines locus data of each of the drawing pixel positions in correspondence with the scanning positions, and stores the determined locus data of each of the drawing pixel positions in correspondence with the scanning positions in a memory, and a drawing position correcting portion which obtains a predetermined drawing shape by adjusting an image which is allocated to each of the drawing pixels on the basis of the locus data stored in the control unit.

In accordance with the above-described structure, since it is possible to easily determine the locus data of each of the drawing pixel positions in correspondence with the scanning positions, via the drawing pixel position measuring device mounted on the moving stage and having a two-dimensional measurement area on the moving stage, the exposure device does not have to be provided with a structure for determining the locus data of each of the drawing pixel positions. Accordingly, it is possible to simplify the structure of the exposure device itself. Further, it is possible to correct the drawing pixel position at a time of exposing and drawing by the respective beams emitted from the side of the device for selectively modulating a plurality of pixels, and to execute the drawing with high precision so as to form an exposed image having high quality, by adjusting the image allocated to each of the drawing pixels due to the drawing position correcting portion, on the basis of at least correcting data stored in the memory of the control unit, relating to the locus of the drawing pixel positions in correspondence with the scanning positions of the predetermined drawing pixels necessary for the correction. Further, it is possible to obtain an inexpensive exposure device with a simple structure, without using a device wherein the structure thereof for finely moving and controlling the relative position between the moving stage and the exposure head in order to correct the drawing pixel position is complicated and expensive.

### Effect Of The Invention

According to the exposure device relating to the present invention, there is an effect that it is possible to obtain an inexpensive device with a simple structure which can form an exposed image having high quality, by correcting the drawing pixel positions when exposing and drawing by the respective beams emitted from the side of the device for selectively modulating a plurality of pixels so as to execute the drawing with high precision.

### BRIEF DESCRIPTION OF THE DRAWINGS

FIG. 1 is an overall schematic perspective view of an image forming device as an exposure device in accordance with an embodiment of the present invention;

FIG. 2 is a schematic perspective view of a main portion showing a state of exposing a photosensitive material by each of exposure heads of an exposure head unit provided in the exposure device in accordance with the embodiment of the present invention;

FIG. 3 is an enlarged schematic perspective view of a main portion showing a state of exposing the photosensitive material by one exposure head in the exposure head unit provided in the exposure device in accordance with the embodiment of the present invention;

FIG. 4 is a schematic configuration drawing of an optical system relating to the exposure head of the exposure device in accordance with the embodiment of the present invention;

FIG. 5A is a plan view of a main portion showing a scanning locus of reflected light images (exposure beams) due to respective micro mirrors in a case where a DMD is not inclined, in the exposure device in accordance with the embodiment of the present invention;

FIG. 5B is a plan view of a main portion showing the scanning locus of the exposure beams in a case where the DMD is inclined, in the exposure device in accordance with the embodiment of the present invention;

FIG. 6 is an enlarged perspective view of a main portion showing an outline structure of the DMD used in the exposure head of the exposure device in accordance with the embodiment of the present invention;

FIG. 7 is an explanatory drawing showing a state where a predetermined plurality of lighted specific pixels are detected by utilizing a plurality of detecting slits relating to the exposure device in accordance with the embodiment of the present invention;

FIG. 8 is an explanatory drawing showing one example of a relative positional relation of a plurality of detecting slits formed on a slit plate, relating to the exposure device in accordance with the embodiment of the present invention;

FIG. 9 is an explanatory drawing exemplifying a strain amount (a strain state) of a drawing detected by a drawing strain amount detecting portion relating to the exposure device in accordance with the embodiment of the present invention;

FIG. 10A is an explanatory drawing showing a state where a position of the lighted specific pixel is detected by utilizing the detecting slit of the exposure device in accordance with the embodiment of the present invention;

FIG. 10B is an explanatory drawing showing a signal at a time when a photo sensor has detected the lighted specific pixel by utilizing the detecting slit of the exposure device in accordance with the embodiment of the present invention;

FIG. 11 is an explanatory drawing showing a means for detecting the lighted specific pixel by utilizing the detecting slit relating to the exposure device in accordance with the embodiment of the present invention;

FIG. 12A is an explanatory drawing exemplifying a drawing strain correction detected by the drawing strain amount detecting portion relating to the exposure device in accordance with the embodiment of the present invention;

FIG. 12B is an explanatory drawing exemplifying the drawing strain correction detected by the drawing strain amount detecting portion relating to the exposure device in accordance with the embodiment of the present invention;

FIG. 12C is an explanatory drawing exemplifying the drawing strain correction detected by the drawing strain amount detecting portion relating to the exposure device in accordance with the embodiment of the invention;

FIG. 12D is an explanatory drawing exemplifying the drawing strain correction detected by the drawing strain amount detecting portion relating to the exposure device in accordance with the embodiment of the present invention;

FIG. 12E is an explanatory drawing exemplifying the drawing strain correction detected by the drawing strain amount detecting portion relating to the exposure device in accordance with the embodiment of the present invention;

FIG. 12F is an explanatory drawing exemplifying the drawing strain correction detected by the drawing strain amount detecting portion relating to the exposure device in accordance with the embodiment of the present invention;

FIG. 13 is an explanatory drawing exemplifying a state where images allocated to each of the drawing pixels are adjusted and drawn, such that a drawing shape becomes a predetermined shape, due to a drawing position correcting portion relating to the exposure device in accordance with the embodiment of the present invention;

FIG. 14 is an explanatory drawing showing an outline of another drawing position correcting portion relating to the exposure device in accordance with the embodiment of the present invention;

FIG. 15 is an explanatory drawing showing an outline of still another drawing position correcting portion relating to the exposure device in accordance with the embodiment of the present invention;

FIG. 16A is an explanatory drawing exemplifying a state where a moving stage moves tortuously in the exposure device in accordance with the embodiment of the present invention;

FIG. 16B is an explanatory drawing exemplifying a state where the moving stage yaws in the exposure device in accordance with the embodiment of the present invention; and

FIG. 17 is a block diagram showing an example of a structure of an electric control system relating to the exposure device in accordance with the embodiment of the present invention.

### BEST MODES FOR IMPLEMENTING THE INVENTION

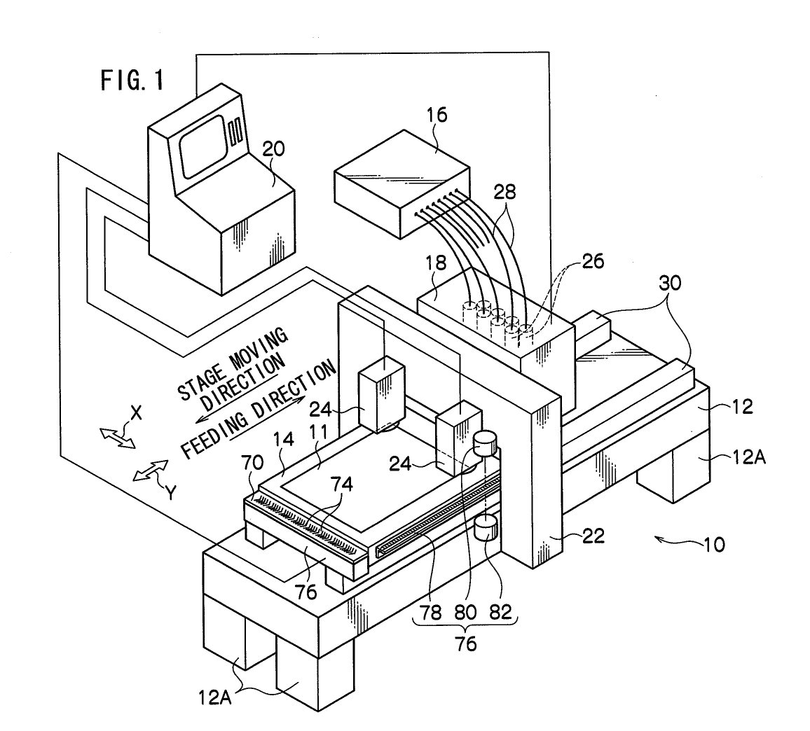

Descriptions will be given of an embodiment relating to an exposure device in accordance with the present invention with reference to FIGS. 1 to 17.

### [Structure Of Image Forming Device]

As shown in FIG. 1, an image forming device 10 configured as an exposure device in accordance with an embodiment of the present invention is configured as a so-called flat-bed type, and is provided mainly with a table 12 supported by four leg members 12A; a moving stage 14 which is disposed on the table 12 and which moves in a direction Y in the figure, and which further moves while a photosensitive material is mounted and fixed thereon, wherein the photosensitive material is obtained by forming a photosensitive material on a surface of a glass substrate, for example, a printed circuit board (PCB), a color liquid crystal display (LCD) or a plasma display panel (PDP); a light source unit 16 which emits multibeams, which include an ultraviolet wavelength region and extend in one direction, as laser beams; an exposure head unit 18 which spatially modulates the multibeams in correspondence with positions of the multibeams, on the basis of desired image data and irradiates the modulated multibeams as exposure beams to the photosensitive material which has a sensitivity to the wavelength region of the multibeams; and a control unit 20 which generates from the image data a modulation signal which is to be supplied to the exposure head unit 18, together with the movement of the moving stage 14.

In the image forming device 10, the exposure head unit 18 for exposing the photosensitive material is arranged above the moving stage 14. A plurality of exposure heads 26 are disposed in the exposure head unit 18. Bundled optical fibers 28 drawn out from the light source unit 16 are connected respectively to the exposure heads 26.

The image forming device 10 is provided with a gate-shaped frame 22 so as to cross the table 12, and a pair of position detecting sensors 24 are respectively attached to the both sides thereof. The position detecting sensor 24 supplies a detected signal at a time of detecting a pass of the moving stage 14 to the control unit 20.

In the image forming device 10, two guides 30 extending along a stage moving direction are disposed on an upper surface of the table 12. The moving stage 14 is mounted on the two guides 30 so as to be reciprocally movable. The moving stage 14 is structured such as to be moved within a moving amount of 1000 mm at a comparatively low constant speed of, for example, 40 mm/sec, by a linear motor (not shown).

In this image forming device 10, the photosensitive material (the substrate) 11 serving as an exposure member mounted to the moving stage 14 is scanned and exposed while being moved with respect to the fixed exposure head unit 18.

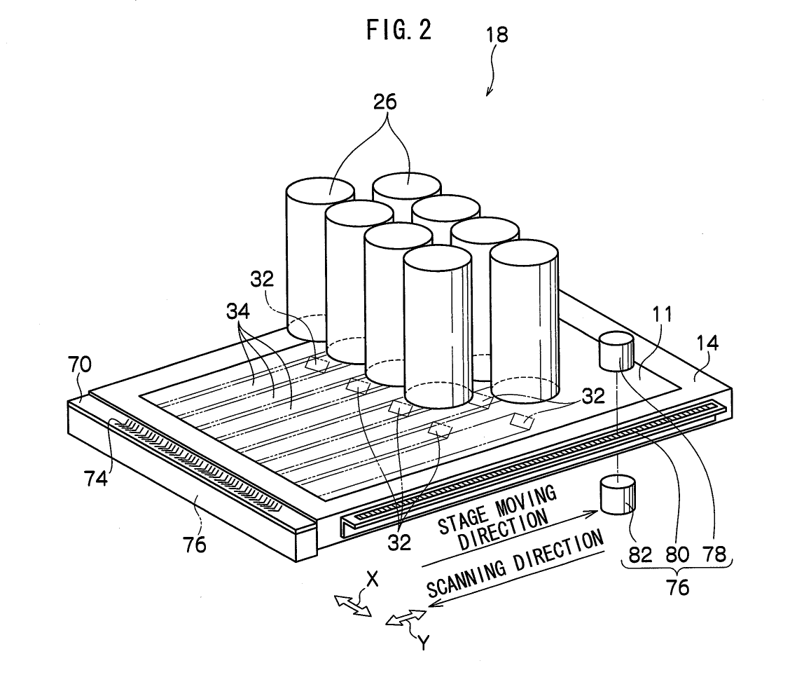

As shown in FIG. 2, a plurality of (for example, eight) exposure heads 26 arranged approximately in a matrix shape with m rows and n columns (for example, two rows and four columns) are disposed in an inner portion of the exposure head unit 18.

An exposure area 32 according to the exposure head 26 is configured, for example, in a rectangular shape having short sides thereof in a scanning direction. In this case, a band-shaped exposed region 34 is formed for each exposure head 26 on the photosensitive material 11 during a moving motion of the scanning exposure.

Further, as shown in FIG. 2, each of the exposure heads 26 in each row are arranged substantially in a line and are arranged so as to be offset at predetermined intervals (a natural number multiple of the long side of the exposure area) in the direction of the substantial line shape, such that the band-shaped exposed regions 34 line up, with no gaps therebetween in a direction orthogonal to the scanning direction. Accordingly, for example, portions between the exposure areas 32 in the first row and the exposure areas 32 in the second row which cannot be exposed are exposed by the exposure areas 32 in the second row.

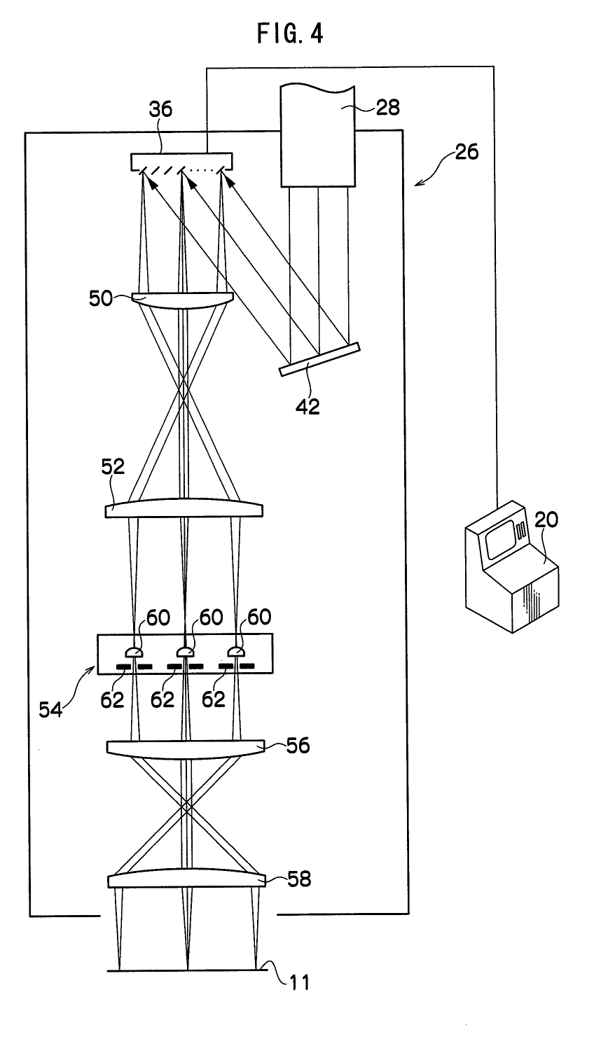

As shown in FIG. 4, each of the exposure heads 26 is provided with a digital micro mirror device (DMD) 36 as a spatial light modulating element which modulates incident light beams for each pixel in according to the image data. The DMD 36 is connected to the control unit (control means) 20 which is provided with a data processing means and a mirror drive control means.

In the data processing portion of the control unit 20, control signals are generated, which drive-control each of the micro mirrors within a region which is to be controlled by the DMD 36 for each of the exposure heads 26, on the basis of the input image data. Further, the mirror drive control means serving as a DMD controller controls angles of reflection surfaces of each of the micro mirrors in the DMD 36 for each of the exposure heads 26, on the basis of the control signals generated in the image data processing portion. Note that the control of the angles of the reflection surfaces will be described later.

To a light incident side of the DMD 36 in each of the exposure heads 26, there is connected the bundle-shaped optical fibers 28 each drawn out from the light source unit 16, serving as a lighting device which emits the multibeams extending in one direction including the ultraviolet wavelength region as the laser beams, as shown in FIG. 1 mentioned above.

An inner portion of the light source unit 16 is provided with a plurality of multiplexing modules (not shown) which multiplex and input the laser beams emitted from a plurality of semiconductor laser chips to the optical fibers. The optical fibers extending from each of the multiplexing modules are multiplexing optical fibers transmitting the multiplexed laser beams, and are bundled together so as to form the bundle-shaped optical fiber 28.

As shown in FIG. 4, at the light incident side of the DMD 36 in each of the exposure heads 26, there is arranged a mirror 42 which reflects the laser beams emitted from a connection end portion of the bundle-shaped optical fiber 28 toward the DMD 36.

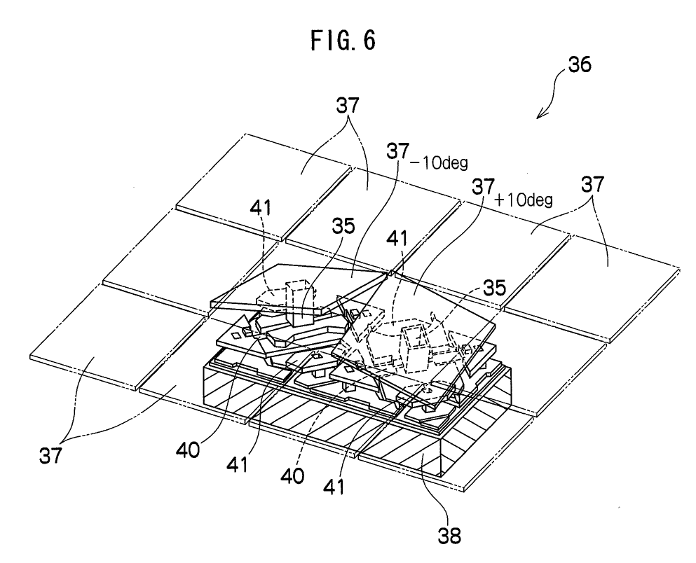

The DMD 36 is structured monolithically (integrally) as a mirror device in which plural (for example, 600×800 in number) micro mirrors 37, which are minute mirrors that form pixels, are arranged in a grid shape, as shown in FIG. 6.

A highly reflective material such as aluminum or the like is evaporated to surfaces of the micro mirrors 37 arranged at the highest portions of each of the pixels. Further, a support column 35 protrudes from a center of a lower surface of each of the micro mirrors 37.

The DMD 36 is configured such that base end portions of the support columns 35 protruding from the micro mirrors 37 are attached to hinges 40 respectively provided on an SRAM cell 38 of a CMOS of a silicone gate, which is manufactured on a normal semiconductor memory manufacturing line, in correspondence with each of the pixels, and the micro mirrors 37 are mounted so as to be inclinable by ±α degrees (±10 degrees) in a diagonal direction with the hinges 40 as axes.

Further, the DMD 36 is configured such that a micro mirror 37 can be drive-controlled to be inclined by +α degrees corresponding to an on state, or inclined by—α degrees corresponding to an off state, by utilizing an electrostatic force generated by electric charges accumulated at one side or the other side of each of mirror address electrodes 41, respectively disposed at both end portions of the diagonal direction along which the micro mirror 37 on the SRAM cell 38 inclines.

In the DMD 36 configured as mentioned above, when a digital signal is written in the SRAM cell 38, the micro mirror 37 at each of the pixels of the DMD 36 is respectively controlled according to image information so as to be in the state where the micro mirror 37 is inclined by +α degrees corresponding to the on state, or the state where the micro mirror 37 is inclined by −α degrees corresponding to the off state around the diagonal direction, with respect to a substrate side where the DMD 36 is disposed, the light incident to the DMD 36 thereby being reflected in inclination directions respective to each of the micro mirrors 37.

Light reflected by a micro mirror 37 in the on state is modulated to an exposed state, and is incident to a projection optical system (see FIG. 4) provided at the light emitting side of the DMD 36. Further, light reflected by a micro mirror 37 in the off state is modulated to a non-exposed state, and is incident to a light absorber (not shown).

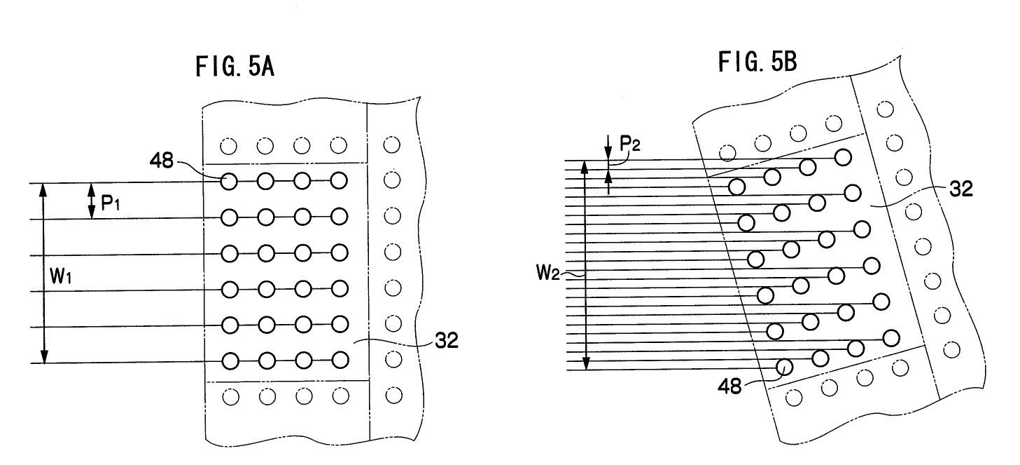

Further, it is preferable that the DMD 36 is arranged so as to be inclined slightly such that a short side direction thereof forms a predetermined angle (for example, an angle between 0.1° and 0.5°) with respect to the scanning direction. FIG. 5A shows a scanning locus of reflected light images (exposure beams) 48 due to the respective micro mirrors when the DMD 36 is not inclined, and FIG. 5B shows the scanning locus of the exposure beams 48 when the DMD 36 is inclined.

In the DMD 36, there are arranged in a short direction many sets of (for example, 600 sets of) micro mirror lines in which plural (for example, 800) micro mirrors 37 are arranged along a longitudinal direction (row direction), however, as shown in FIG. 5B, by inclining the DMD 36, a pitch P2 between the scanning locus (scanning line) of the exposure beams 48 caused by each of the micro mirrors 37 can be made smaller than a pitch P1 between the scanning lines in the case in which the DMD 36 is not inclined, thereby making it possible to significantly improve resolution. Since, when the DMD 36 is inclined, the angle of inclination of the DMD 36 is minute, a scanning width W2 is approximately identical to a scanning width WI in the case in which the DMD 36 is not inclined.

Further, approximately the same position (dot) on the same scanning line is overlappingly exposed (multiply-exposed) by the different micro mirror lines. In this manner, it is possible to control a minute amount of the exposure position by the multiple exposure, and it is possible to achieve a high-definition exposure. Further, it is possible to join areas between the plural exposure heads arranged in the scanning direction with no step, due to the controlling of the exposure position control by a minute amount.

In this case, in place of inclining the DMD 36, the same effect can be obtained if the respective micro mirror lines are offset at a predetermined interval in a direction orthogonal to the scanning direction so as to be arranged in a zigzag manner.

Next, a description will be given of the projection optical system (an imaging optical system) provided at a light reflected side of the DMD 36 in the exposure head 26. As shown in FIG. 4, the projection optical system provided at the light reflection side of the DMD 36 in each of the exposure heads 26 is configured by arranging optical members for exposing, such as a lens system 50 and 52, a micro lens array 54, and an objective lens system 56 and 58, in that order from the side of the DMD 36 toward the photosensitive material 11, in order to project a light source image on the photosensitive material 11 disposed on an exposure surface at the light reflected side of the DMD 36.

In this case, the lens system 50 and 52 is configured as an enlarging optical system, which enlarges an area of the exposure area 32 (illustrated in FIG. 2) on the photosensitive material 11 to a desired magnitude by enlarging a cross sectional area of a bundle of light rays reflected by the DMD 36.

As shown in FIG. 4, the micro lens array 54 is structured such that a plurality of micro lenses 60 are integrally formed thereat, the micro lenses one-on-one corresponding to the respective micro mirrors 37 of the DMD 36, which reflects the laser lights irradiated through the respective optical fibers 28 from the light source unit 16. Each of the micro lenses 60 are respectively arranged on optical axes of each of the laser beams which are each transmitted through the lens system 50 and 52.

The micro lens array 54 is formed in a rectangular flat plate shape, and apertures 62 are respectively integrally arranged in portions where each of the micro lenses 60 are formed. The apertures 62 are structured as aperture stops which are arranged one-on-one corresponding to each of the micro lenses 60.

As shown in FIG. 4, the objective lens system 56 and 58 is structured, for example, as a unit magnification optical system. Further, the photosensitive material 11 is placed at a rear focal point position of the objective lens system 56 and 58. Note that each of the lens system 50 and 52, and the objective lens system 56 and 58 in the projection optical system is respectively shown as one lens in FIG. 4, however, may be constituted by a combination of a plurality of lenses (for example, a convex lens and a concave lens).

The image forming device 10 structured as mentioned above is provided with a drawing distortion amount detecting portion (a distortion amount detecting means) for appropriately detecting distortions in each of the lens system 50 and 52 and the objective lens system 56 and 58 in the projection optical system of the exposure head 26, a drawing distortion amount changing over time when executing the exposure process by the exposure head 26 due to various factors.

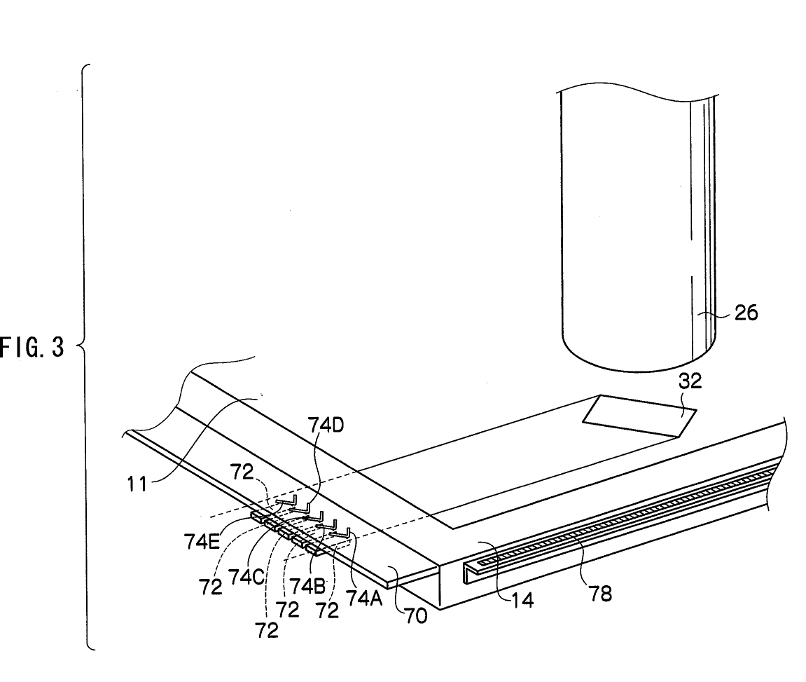

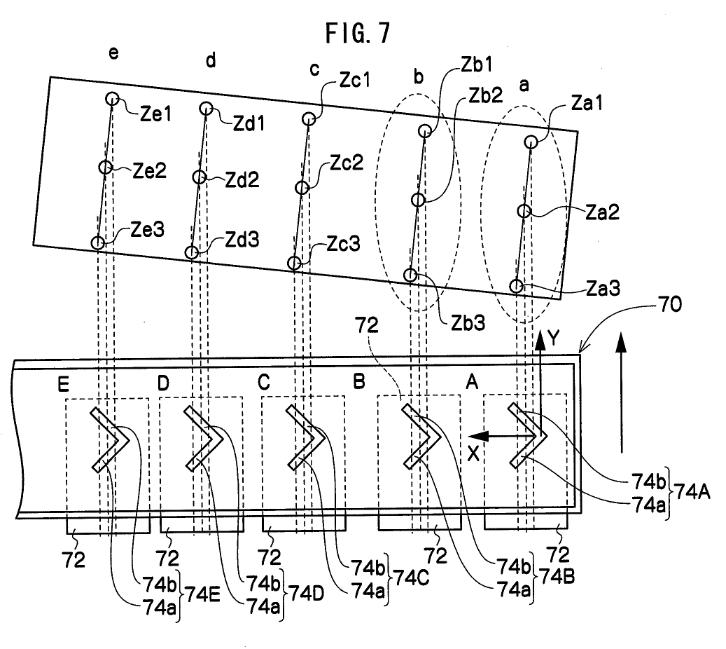

As a part of the drawing distortion amount detecting portion, a beam position detecting portion for detecting irradiated beam positions is arranged at an upstream side in a feeding direction of the moving stage 14, in the image forming device 10, as shown in FIGS. 3 and 7.

The beam position detecting portion has a slit plate 70 integrally attached to an edge portion at the upstream side along the feeding direction (the scanning direction) of the moving stage 14, with photo sensors 72 serving as light detecting means (detectors) arranged at a reverse side of the slit plate 70.

Detecting slits 74 (A, B, C, D, E and the like) are cut in the slit plate 70, wherein a light shielding thin chrome film (a chrome mask or an emulsion mask) is formed on a rectangular silica glass plate having a length corresponding to a length in a full width direction of the moving stage 14, and the detecting slits 74 are respectively formed at a plurality of predetermined positions of the chrome film by removing the chrome film in substantially L-shaped portions which open at right angles toward an X-axis direction due to an etching process (for example, a process of masking the chrome film, patterning the slits and eluting the slit portions of the chrome film by an etching solution) so as to allow the laser beams (the light beams) to pass (to be transmitted).

Since the slit plate 70 structured as mentioned above is made of silica glass, errors caused by temperature change do not easily arise, and it is possible to detect the beam positions with high precision by utilizing the thin chrome film for light shielding.

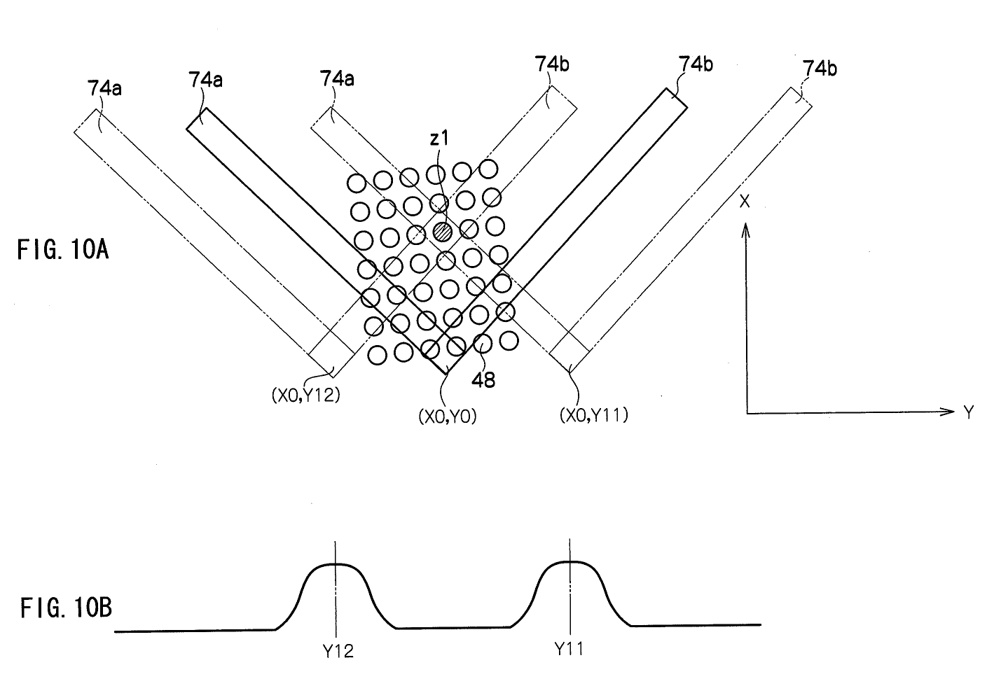

As shown in FIGS. 7 and 10A, the substantially L-shaped detecting slits 74 are formed as a set having a shape which is obtained by connecting a linear first slit portion 74a positioned at the upstream side in the feeding direction and having a predetermined length and a linear second slit portion 74b positioned at a downstream side in the feeding direction and having a predetermined length orthogonally at respective one end portions. In other words, the first slit portion 74a and the second slit portion 74b are orthogonal to each other, and are structured such that the first slit portion 74a has an angle of 135 degrees with respect to a Y-axis direction (a traveling direction), and the second slit portion 74b has an angle of 45 degrees with respect to the Y-axis direction. Note that, in the present embodiment, the scanning direction is the Y-axis direction, and the direction orthogonal thereto (the direction in which the exposure heads 26 are arranged) is the X-axis direction.

Note that it is sufficient that the first slit portion 74a and the second slit portion 74b are arranged so as to form a predetermined angle with each other, and the first slit portion 74a and the second slit portion 74b may be arranged separately, in addition to the configuration in which the two portions intersect with each other.

Note that although in the figures the first slit portions 74a and the second slit portions 74b of the detecting slits 74 are formed so as to form angles of 45 degrees with respect to the scanning direction, the first slit portions 74a and the second slit portions 74b may be configured such that the angles with respect to the scanning direction may be set optionally or may form a tapered shape, as far as they incline with respect to the scanning direction, that is, the stage moving direction (a state in which they are arranged so as not to be in parallel to each other), as well as inclining with respect to the pixel arrangement of the exposure heads 26.

The photo sensors 72 (the CCD, the CMOS, the photo detector or the like) that respectively detect the light from each of the exposure heads 26 are respectively arranged at predetermined positions directly below detecting slits 74.

As shown in FIGS. 1 and 2, in the beam position detecting portion provided in the image forming device 10, a linear encoder 76 serving as a moving position detecting portion for detecting the position of the moving stage 14 is arranged at a side portion along the feeding direction of the moving stage 14.

The linear encoder 76 may use a generally available linear encoder. The linear encoder 76 includes a scale plate 78, which is integrally attached to the side portion along the feeding direction (the scanning direction) of the moving stage 14, and which is provided at a flat surface portion thereof with fine slit-shaped scales at fixed intervals for allowing the light to be transmitted, and further includes an optical transmitter 80 and an optical receiver 82 which are firmly fixed to a fixed frame (not shown) provided on the table 12 so as to hold the scale plate 78 therebetween.

The linear encoder 76 is configured to emit measuring beams from the optical transmitter 80, detect the measuring beams passing through the fine slit-shaped scales of the scale plate 78 via the optical receiver 82 arranged at the reverse side, and transmit the detected signals to the control unit 20.

In the linear encoder 76, the measuring beams emitted from the optical transmitter 80 are intermittently shut off by the scale plate 78 moving integrally with the moving stage 14 and are incident to the optical receiver 82, at a time of moving the moving stage 14 from an initial position.

Accordingly, in this image forming device 10, the control unit 20 counts the number of times light has been received by the optical receiver 82, and the control unit 20 can be aware of the moving position of the moving stage 14.

In this image forming device 10, the control unit 20 serving as the control means is provided with an electric system which forms a part of the distortion amount detecting portion.

The control unit 20, as well as having an instruction input means with switches for inputting user commands, also has a CPU and a memory serving as a control device which is also a part of a distortion amount computing means (not shown). The control device is capable of drive-controlling the respective micro mirrors 37 in the DMD 36.

Further, the control device receives output signals of the optical receiver 82 of the linear encoder 76, as well as output signals from each of the photo sensors 72, and applies a distortion correcting process with respect to the image data on the basis of information that relates the position of the moving stage 14 to the output state from the photo sensors 72. Thereby, a suitable control signal is generated, the DMD 36 is controlled, and the moving stage 14 to which the photosensitive material 11 is mounted in the scanning direction is drive-controlled.

Further, the control device controls the various devices relating to overall exposure process motions of the image forming device 10, such as the light source unit 16 necessary at a time of executing the exposure process at the image forming device 10.

Next, a description will be given of a means for detecting the beam positions by utilizing the detecting slits 74 and the linear encoder 76 in the drawing distortion amount detecting portion provided in the image forming device 10.

First, a description will be given of a means for specifying a position actually irradiated on the exposure surface at a time of lighting a single specific pixel Z1, which is a measured pixel, by utilizing the detecting slits 74 and the linear encoder 76, in the image forming device 10.

In this case, the control device moves the moving stage 14 and positions a predetermined detecting slit 74 for a predetermined exposure head 26 of the slit plate 70 beneath the exposure head unit 18.

Next, the control device controls only the specific pixel Z1 in a predetermined DMD 36 so as to make it be in an on state (a lighted state).

Further, the control device moves the detecting slit 74 to a desired position (for example, an point set to be an original position) on the exposure area 32, as shown by the unbroken line in FIG. 10A, by controlling and moving the moving stage 14. At this time, the control device recognizes an intersection point of the first slit portion 74a and the second slit portion 74b as (X0, Y0) and stores it in the memory. Note that, in FIG. 10A, a direction rotating in a counterclockwise direction from the axis Y indicates a positive angle.

Next, the control device starts moving the detecting slit 74 to the right side of FIG. 10A along the axis Y, by controlling and moving the moving stage 14.

Further, the control device computes positional information of the specific pixel Z1 from a relation between a moving position of the moving stage 14 and the transition of an output signal at the time when the light from the lighted specific pixel Z1 passes through a position indicated by an imagined line at the right side of FIG. 10A, and passes through the first slit portion 74a and is detected by the photo sensor 72, as exemplified in FIG. 10B. The control device then recognizes the intersection point of the first slit portion 74a and the second slit portion 74b as (X0, Y11) and stores it in the memory.

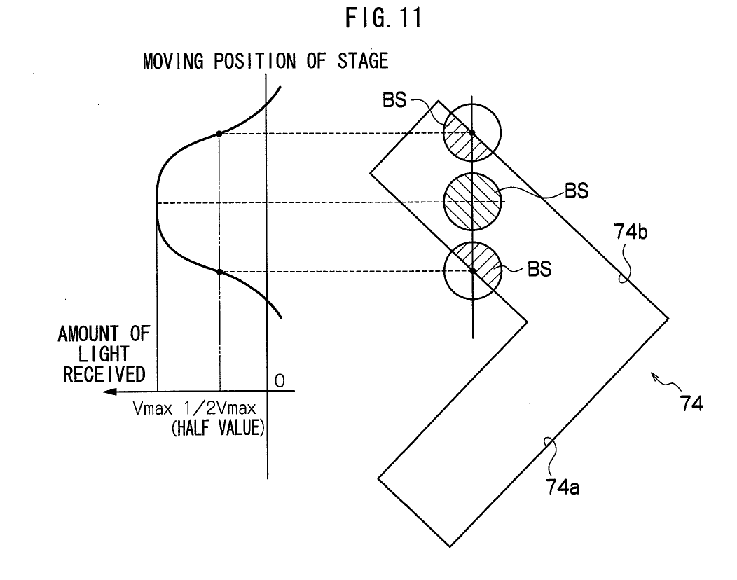

In this beam position detecting portion, since a slit width of the detecting slit 74 is formed sufficiently wider than a beam spot BS diameter, a position where the detected value of the photo sensor 72 is maximum extends over a certain range, as shown in FIG. 11. Therefore, the position where the detected value of the photo sensor 72 is at a maximum value cannot be set to be the position of the specific pixel Z1.

Accordingly, the control device calculates a half value which is half of the maximum value detected by the photo sensor 72. Further, the control device determines two positions (the moving positions of the moving stage 14) at a time when the output of the photo sensor 72 comes to the half value while continuously moving the moving stage 14, respectively on the basis of the detected values of the linear encoder 76.

Next, the control device calculates a center position between a first position and a second position where the output of the photo sensor 72 comes to the half value. Further, the control device stores the calculated center position as positional information of the specific pixel Z1 (the intersection point of the first slit portion 74a and the second slit portion 74b as (X0, Y11)) in the memory. Accordingly, it is possible to determine the center position of the beam spot BS as the position of the specific pixel Z1.

Further, in this control device, it is desirable to accurately determine the two positions (the moving positions of the moving stage 14) at a time when the output of the photo sensor 72 comes to the half value by adopting a so-called moving average (a so-called filter process). Due to this, in the control device, it is possible to remove noise components and obtain more accurate positional information of the specific pixel Z1.

In this control device, errors are reduced by adding up all sampling values which are the output values of the photo sensor 72 corresponding to a predetermined number N of pieces of positional information detected by the linear encoder 76, and dividing it by the predetermined number N, thereby determining the moving average of the center positions in a range of the predetermined number N detected by the linear encoder 76.

Next, the control device moves the moving stage 14 and starts moving the detecting slit 74 to the left side of FIG. 10A along the axis Y. Further, the control device computes the positional information of the specific pixel Z1, with the same method as described in FIG. 11 mentioned above, from a relation between a moving position of the moving stage 14 and the transition of an output signal at the time when the light from the lighted specific pixel Z1 passes through a position indicated by an imagined line at the left side of FIG. 10A, and passes through the first slit portion 74a and is detected by the photo sensor 72, as exemplified in FIG. 10B. The control device then recognizes the intersection point of the first slit portion 74a and the second slit portion 74b as (X0, Y12) and stores it in the memory.

Next, the control device reads out the coordinates (X0, Y11) and (X0, Y12) stored in the memory, and determines the coordinate of the specific pixel Z1, and carries out an operation in accordance with the following expression in order to determine the actual position. In this case, if the coordinate of the specific pixel Z1 is set to be (X1, Y1), X1 is expressed by X1=X0+(Y11−Y12)/2 and Y1 is expressed by Y1=(Y11+Y12)/2.

Note that if the detecting slit 74 having the second slit portion 74b intersecting with the first slit portion 74a, and the photo sensor 72 are used in combination as mentioned above, the photo sensor 72 detects only the light in a predetermined range where the first slit portion 74a or the second slit portion 74b allows the light to pass through. Accordingly, the photo sensor 72 does not require a detailed and specific structure for detecting the amount of light only in a narrow range corresponding to the first slit portion 74a or the second slit portion 74b, and may make use of readily available and inexpensive structures.

Next, a description will be given of a means for detecting the drawing distortion amount in the exposure area (the overall exposure region) 32 where an image can be projected on the exposure surface by one exposure head 26, in the image forming device 10.

In order to detect the distortion amount of the exposure area 32 taken as the overall exposure region, the image forming device 10 is configured such that a plurality of detecting slits 74, for example, five in the present embodiment, may simultaneously detect positions with respect to one exposure area 32, as shown in FIG. 3.

Accordingly, a plurality of measured pixels averagely dispersed and dotted within the exposure areas as the measured objects are set within the exposure area 32 by one exposure head 26. In the present embodiment, five sets of the measured pixels are set. The plurality of measured pixels are set at objective positions with respect to the center of the exposure area 32. In the exposure area 32 shown in FIG. 7, two paired sets of measured pixels Za1, Za2, Za3, Zb1, Zb2 and Zb3 and two paired sets of measured pixels Zd1, Zd2, Zd3, Ze1, Ze2 and Ze3 are symmetrical with respect to a set of measured pixels Zc1, Zc2 and Zc3 (in this case, three measured pixels form one set) arranged at the center position in the longitudinal direction thereof.

Further, as shown in FIG. 7, five detecting slits 74A, 74B, 74C, 74D and 74E are arranged in the slit plate 70 at corresponding positions so as to be capable of detecting the respective sets of the measured pixels.

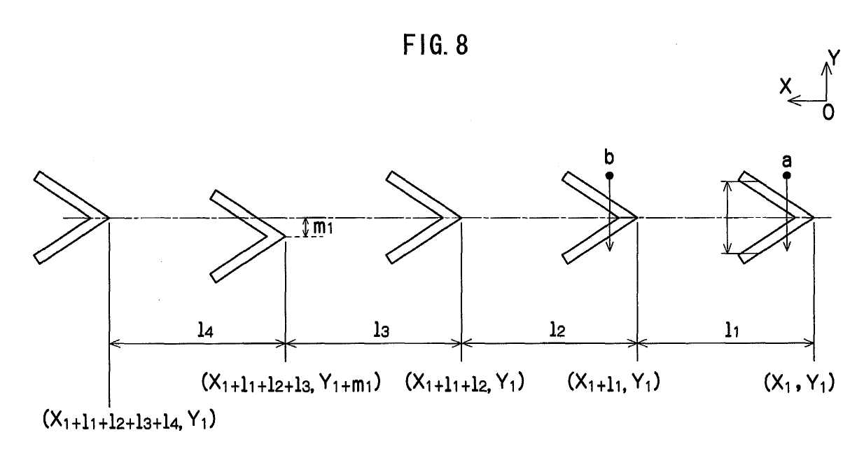

Further, in order to easily execute a computing at a time of adjusting machining errors between five detecting slits 74A, 74B, 74C, 74D and 74E previously formed in the slit plate 70, a relation of the relative coordinate positions of the intersection points of the first slit portions 74a and the second slit portions 74b is determined. For example, in the slit plate 70 shown in FIG. 8, when setting the coordinate (X1, Y1) of the first detecting slit 74A as a basis, the coordinate of the second detecting slit 74B becomes (X1+11, Y1), the coordinate of the third detecting slit 74C becomes (X1+11+12, Y1), the coordinate of the fourth detecting slit 74D becomes (X1+11+12+13, Y1+m1), and the coordinate of the fifth detecting slit 74E becomes (X1+11+12+13+14, Y1).

Next, in a case where the control device detects the distortion amount of the exposure area 32 on the basis of the conditions mentioned above, the control device controls the DMD 36, and sets a predetermined group of measured pixels (Za1, Za2, Za3, Zb1, Zb2, Zb3, Zc1, Zc2, Zc3, Zd1, Zd2, Zd3, Ze1, Ze2, Ze3) to an on state and moves the moving stage 14 provided with the slit plate 70 directly beneath each of the exposure heads 26, thereby determining the coordinates with respect to the respective measured pixels by utilizing the corresponding detecting slits 74A, 74B, 74C, 74D and 74E. At this time, the predetermined group of measured pixels may be individually set to the on state, or all the measured pixels may be set to the on state and be detected.

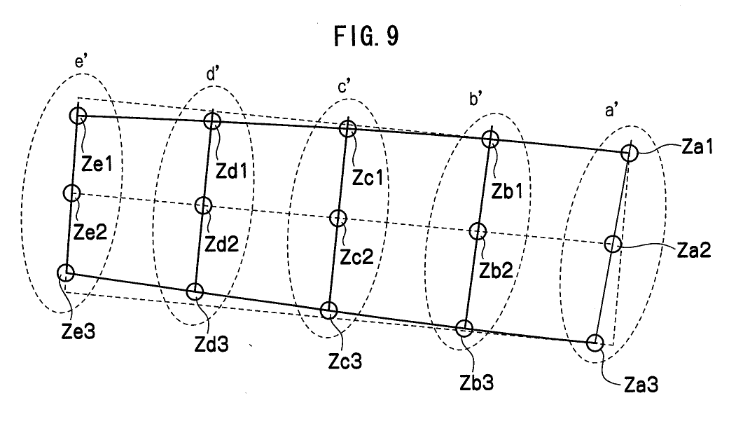

Next, the control device determines the drawing distortion amount (the distortion state) within the exposure area 32 as exemplified in FIG. 9, by respectively computing relative displacements on the basis of positional information of the reflection surfaces of the predetermined micro mirrors 37 corresponding to each of the measured pixels in the DMD 36, and exposure point positional information of the predetermined light beams which are projected to the exposure surface (the exposure area 32) from the predetermined micro mirrors 37, and detected by utilizing the detecting slits 74 and the linear encoder 76.

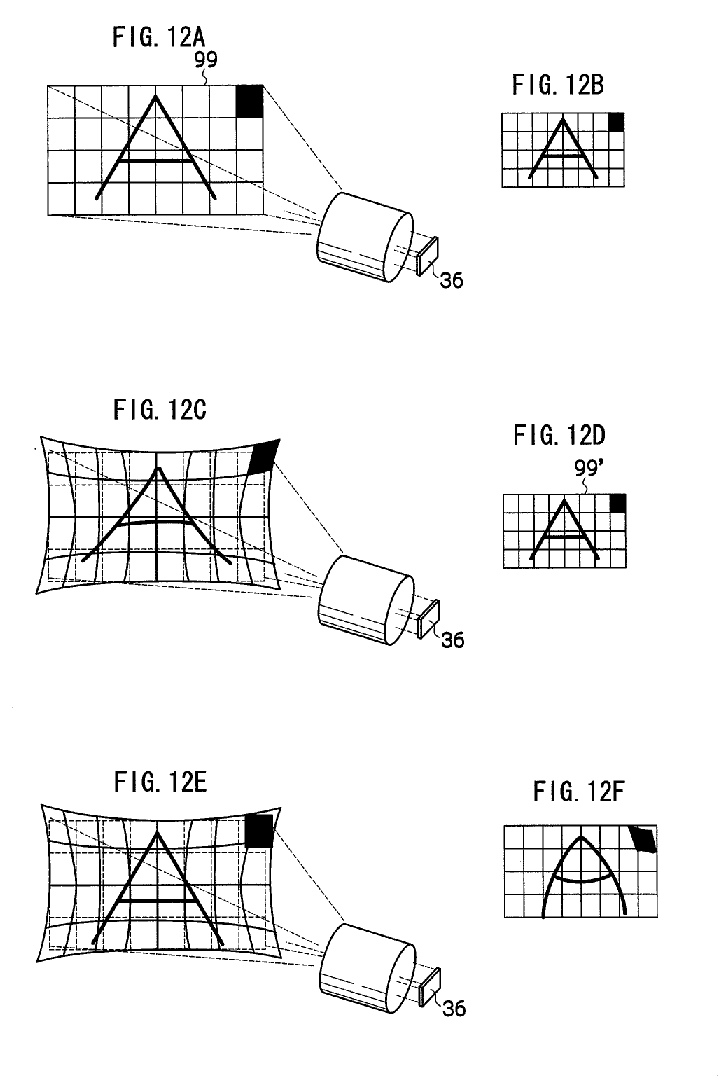

FIGS. 12A to 12F show the drawing strain within one head, a correcting method thereof, and the influence thereby on the image.

As shown in FIG. 12A, when there is no distortion in the optical system and the photosensitive material, the image data input to the DMD 36 is not particularly corrected as shown in FIG. 12B, and is output on the photosensitive material 11 as it is, whereby an ideal image is drawn as shown in FIG. 12A.

However, if a drawing distortion, due to the factors such as temperature or vibration at the time of the exposure process by the emitted beams, is generated in the image within one head, an image 99 exposed in the exposure area 32 is deformed as shown in FIG. 12C (if the image which is not corrected were input to the DMD 36 as it is). Accordingly, correction is necessary.

Accordingly, as shown in FIG. 12F, a correct image 99′ without distortion can be obtained by correcting the image data input to the DMD 36, determining the drawing distortion amount by the distortion amount computing means, on the basis of the positional information obtained by detecting the image itself output onto the photosensitive material 11 by the beam position detecting portion, and properly correcting according to the detected drawing distortion amount.

In this image forming device 10, proper corrections are executed by applying a correcting process to the image data capable of being applied to the image forming device 10, or to the exposure point coordinate data, or the like, on the basis of the drawing distortion amount (the distortion state) detected by the drawing distortion amount detecting portion as mentioned above (for example, a conventional distortion correcting means that utilizes as the exposure point coordinate data an actually measured value [a value computed from the distortion amount]), then, the DND 36 is controlled and a drawing pattern is exposed with high precision, improving the quality of the process of pattern exposing on the photosensitive material.

Note that, in the image forming device 10 mentioned above, description has been given of a structure in which a plurality of detecting slits 74A, 74B, 74C, 74D and 74E are formed in the slit plate 70, and the photo sensors 72 are provided corresponding to each of these, however, the structure may also be made such that the position detection is executed for each set of the measured pixels by moving both a single detecting slit 74 and a single photo sensor 72 in the direction of the axis X with respect to the moving stage 14.

In this case, the movement positional information with respect to the direction of the axis X of the combination of the single detecting slit 74 and the single photo sensor 72, and the exposure point positional information actually irradiated on the exposure surface at a time of lighting the measured pixel are computed, and the drawing distortion amount (the distortion state) is determined.

In this image forming device 10, in order to correct positional errors concomitant with the scanning at a time of moving and scanning the moving stage 14, means for detecting the position of the moving stage 14 is prepared. Since the position detecting portion (the position detecting means) of the moving stage 14 is utilized at a time when the moving state of the moving stage 14 changes, such as adjusting work that takes place when manufacturing the image forming device 10 or the like, the position detecting portion is provided independently from the main body of the image forming device 10. Note that the position detecting portions of the moving stage 14 may be structured integrally with the image forming device 10.

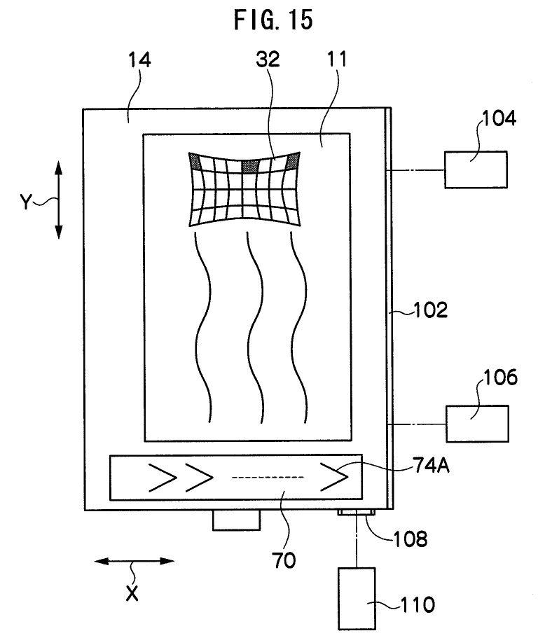

As shown in FIG. 15, the position detecting portion of the moving stage 14 is arranged corresponding to one side surface along the scanning direction of the moving stage 14, and a side surface at a rear end of the feeding direction (a side surface where the slit plate 70 is arranged).

In the position detecting portion of the moving stage 14, a mirror member 102 for reflecting the laser beams is integrally disposed at one side surface along the scanning direction of the moving stage 14, and laser beam distance measuring devices 104 and 106 serving as a distance measuring means are arranged respectively at two positions spaced at a predetermined interval so as to oppose to the mirror member 102.

These two laser beam distance measuring devices 104 and 106 are configured such that each of them can measure a distance in a direction (a direction shown by an arrow Y in the figure) orthogonal to the scanning direction of the moving stage 14.

Additionally, the two laser beam distance measuring devices 104 and 106 arranged so as to be spaced at the predetermined interval are configured such as to be capable of measuring an angle of rotation at a time when the moving stage 14 rotates during moving and scanning on the basis of a difference between the respectively detected distances with respect to the mirror member 102.

Further, in the position detecting portion of the moving stage 14, a mirror member 108 for reflecting the laser beams is integrally disposed at a predetermined position of the other side surface (a side surface where the slit plate 70 is arranged) along the direction orthogonal to the scanning direction of the moving stage 14, and a laser beam distance measuring device 110 serving as a distance measuring means is arranged at a predetermined position opposing to the mirror member 108.

The laser beam distance measuring device 110 is configured such as to be capable of measuring a distance in the scanning direction of the moving stage 14. Note that if sufficient precision can be obtained, the laser beam distance measuring device 110 can be substituted by the linear encoder 76 disposed on the moving stage 14.

When measuring the position of the moving stage 14 by the position detecting portion of the moving stage 14 configured as mentioned above, a moving locus and a rotational fluctuation state of the moving stage 14 are detected when aligning the image forming device or the like, by measuring the position of the moving stage 14 consecutively by the respective laser beam distance measuring devices 104 and 106 and the laser beam distance measuring device 110, while executing a motion of moving the moving stage 14 from a position where the moving stage 14 is moved to a position furthest upstream in the scanning direction to a position furthest downstream in the scanning direction.

In other words, in the position detecting portion of the moving stage 14, there is executed an operation of detecting the moving position of the moving stage 14 moving toward the feeding direction by the laser beam distance measuring device 110, and detecting the respective positions by the laser beam distance measuring devices 104 and 106 at the measuring positions.

Accordingly, in the position detecting portion of the moving stage 14, there is stored, in a scanning state table set in the memory region of the control unit 20, a data group of the measured values of the distance with respect to the direction (a direction shown by the arrow Y in the figure) orthogonal to the scanning direction of the moving stage 14, corresponding to the respective measuring positions in the scanning direction (the direction shown by the arrow Y in the figure) of the moving stage 14.

The position detecting portion of the moving stage 14, may be configured such that the data group of the measured values of the detected distance are computed and repaired, the moving locus data in the scanning direction of the moving stage 14 and transition data of the rotational change of the moving stage 14 are determined, and the determined result is stored in the scanning state table set in the memory region of the control unit 20.

The position detecting portion of the moving stage 14, may be configured such that the data group of the measured value of the detected distance are computed and repaired, vector data at a time of scanning and moving the moving stage 14 is determined and the determined vector data is stored in the scanning state table set in the memory region of the control unit 20.

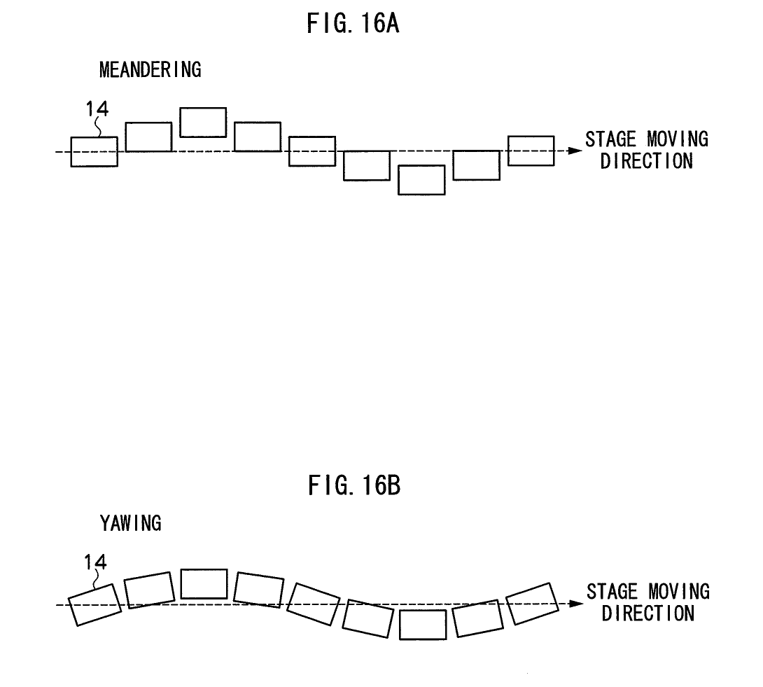

The data relating to the moving and scanning of the moving stage 14 stored in the scanning state table of the control unit 20 as mentioned above can be utilized, at a time of scanning and exposing on the photosensitive material 11 in the image forming device 10, for example, in a case of correcting a meandering motion of the moving stage 14, as shown in FIG. 16A, or in a case of executing a correction taking into consideration yawing, as shown in FIG. 16B. Note that yawing means a motion obtained by adding the rotation of the moving stage 14 to the meandering motion of the moving stage 14 as shown in FIG. 16A.

When yawing of the moving stage 14 is generated as mentioned above, because of the rotation of the moving stage 14, the moving distance in the scanning direction of the moving stage 14 at a predetermined exposure timing pitch changes, as does a position of an image of the exposure beam 48 caused by the micro mirrors 37 on the photosensitive material 11 which is mounted to the moving stage 14. In other words, a local speed fluctuation is generated due to the rotation of the moving stage 14 when yawing is generated, so it is only necessary to execute correction to change the number of the exposure point data according to the image positional fluctuation of the exposure beam 48 and the speed fluctuation information. Note that it is possible to consider only the rotational component by setting the meandering component to 0.

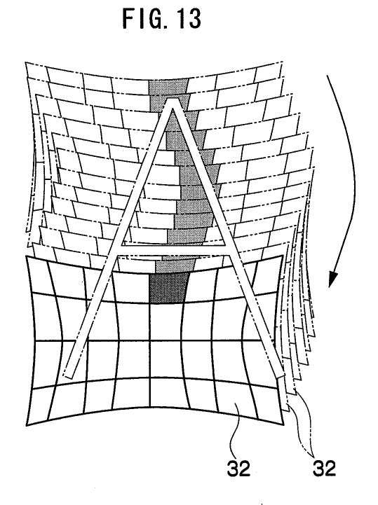

Next, a description will be given of a drawing position correcting portion, wherein the locus of the drawing pixel positions corresponding to the scanning positions of each of the drawing pixels are measured, the locus data (information) of the positions are stored in the memory of the control unit 20, and the image allocated to each of the drawing pixels are adjusted according to the locus information of the positions such that the drawing shape becomes a predetermined shape as exemplified in FIG. 13, in order to correct the distortion errors due to each of the exposure heads 26 and the positional errors concomitant with the moving and scanning of the moving stage 14 by means of the image forming device 10 as a digital exposure device.

In this drawing position correcting portion, the drawing position correction for obtaining the predetermined drawing shape is executed on the basis of the desired correcting data which is previously stored in the scanning state table set in the predetermined region of the memory within the control unit 20 of the image forming device 10.

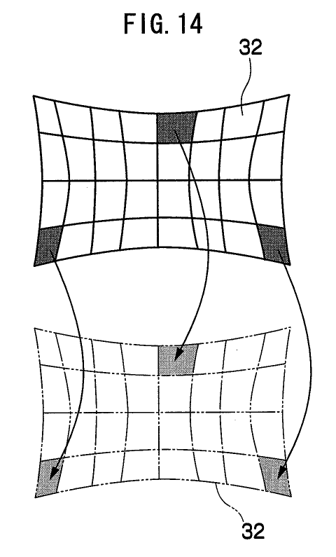

As a first drawing position correcting portion, in this image forming device 10, for example, as shown in FIG. 14, coordinates of the positions of a plurality of predetermined pixels 48A which are the exposure beams 48 in the exposure head 26 averagely dispersed and lighted as representative points at a time of correcting each of the pixels in the exposure area 32, are detected by utilizing the detecting slits 74 serving as the detecting means of the drawing pixel positions which are the exposure beam positions mentioned above respectively shown in FIGS. 1 to 3 and FIGS. 7 to 11 (the plurality of predetermined pixels 48A may be those utilized for controlling each of the micro mirrors 37 of the DMD 36 in the exposure head 26 and may be specific points such as the sampling points or the like capable of ensuring a requested precision of the drawing). At this time, in the image forming device 10, the coordinates of the position of the moving stage 14, at the specific scanning positions where the coordinates of the positions of the plurality of predetermined pixels 48A are measured, are detected by utilizing the linear encoder 76 shown in FIGS. 1 to 3 or utilizing the mirror member 108 and the laser beam distance measuring device 110 shown in FIG. 14.

Further, in this image forming device 10, position data is generated in which the coordinates of the position of the moving stage 14 at a specific scanning position are related to the coordinates of each of the positions of the plurality of predetermined pixels 48A at the specific scanning position, and the position data is stored in the scanning state table set in the memory region (not shown) in the memory of the control unit 20.

Next, in this image forming device 10, the moving stage 14 is moved to the next specific scanning position by a predetermined measuring distance, and the coordinates of the positions of the plurality of predetermined pixels 48A are respectively detected by utilizing the detecting slits 74 serving as the detecting means of the drawing pixel positions each mentioned above shown in FIGS. 1 to 3 and FIGS. 7 to 11, and the coordinates of the moving stage 14, at the specific scanning position where the coordinates of the positions of the plurality of predetermined pixels 48A are measured at this time, is detected by utilizing the linear encoder 76 shown in FIGS. 1 to 3 or by utilizing the mirror member 108 and the laser beam distance measuring device 110 shown in FIG. 14.

Further, in this image forming device 10, position data in which the coordinate of the position of the moving stage 14 at a next specific scanning position is related to the coordinates of each of the positions of the plurality of predetermined pixels 48A at the next specific scanning position are generated, and the position data are stored in the scanning state table set in the memory region (not shown) in the memory of the control unit 20.

In this image forming device 10, a group of position data corresponding to the whole exposure range at a time of moving and scanning the moving stage 14 to execute an exposure process is stored and held in the scanning state table set in the memory region of the control unit 20, by sequentially storing the position data at each of the specific scanning positions detected as mentioned above in the scanning state table set in the memory region of the memory of the control unit 20.

Note that the image forming device 10 may be configured such that a computing process, which calculates the undetected positions of each of the pixels, is executed by a generally used interpolation method on the basis of the position data corresponding to the detected positions of the plurality of predetermined pixels 48A, and the positions of all the pixels, including the undetected positions of each of the pixels which have been calculated, are stored and held in the scanning state table, set in the memory region of the control unit 20.

As a second drawing position correcting portion, in the image forming device 10, for example, as shown in FIG. 15, the drawing distortion amount (the single distortion state as exemplified in FIG. 9) within the exposure area 32 is determined and stored in the scanning state table set in the memory region of the control unit 20, the vector data at a time of scanning and moving the moving stage 14 is determined by the position detecting portion of the moving stage 14 and stored in the scanning state table set in the memory region of the control unit 20.

Further, in this image forming device 10, during the drawing operation, the locus of the respective drawing pixel positions at a time when the respective pixels actually execute drawing at the respective scanning positions during the moving stage 14 moving are computed and determined on the basis of the drawing distortion amount within the single exposure area 32 and the vector data during the scanning and moving of the moving stage 14, and the correction according to the locus of each of the detected drawing pixel positions is executed such that drawing distortions and the displacement during scanning are rectified, and the DMD 36 is drive-controlled, whereby a correct image without distortion is finally obtained.

In other words, in the image forming device 10 provided with the second drawing position correcting portion, the drawing pixel positions are detected by utilizing the detecting slits 74 serving as the detecting means of the drawing pixel positions mentioned above shown in FIGS. 1 to 3 and FIGS. 7 to 11, when the moving stage 14 is at the predetermined detecting position, and are stored in the scanning state table set in the memory region of the control unit 20.

Further, in the image forming device 10 provided with the second drawing position correcting portion, the data of the measured values of the distances detected by utilizing the mirror member 102, the laser beam distance measuring devices 104 and 106, the mirror member 108 and the laser beam distance measuring device 110, which serve as the position detecting portion of the moving stage 14, are computed, the vector data during the scanning and moving of the moving stage 14 are determined, and the determined vector data are stored in the scanning state table set in the memory region of the control unit 20.

Next, as a third drawing position correcting portion, in the image forming device 10, the moving stage 14 is scanned in a state where the photosensitive material 11 serving as the drawn medium is mounted on the moving stage 14 and the pixels are exposed by the plurality of predetermined exposure beams which are lighted as the representative points in the exposure area 32 of the exposure head 26, whereby the image obtained by drawing the locus of each of the drawing pixel positions is actually formed.

Further, the locus data of each of the drawing pixel positions corresponding to the scanning positions are determined by measuring the locus of each of the drawing pixel positions, being the drawn image drawn on the photosensitive material 11, by a separately prepared position measuring device. The locus data of each of the drawing pixel positions corresponding to the scanning positions determined as mentioned above are stored in the scanning state table set in the memory region of the control unit 20 of the image forming device 10.

Further, in this image forming device 10, during the drawing operation, the control unit 20 executes correcting, on the basis of the locus data of each of the drawing pixel positions corresponding to the scanning positions which are read out from the scanning state table set in the memory region, so as to resolve the drawing distortion state or the displacement during the scanning, and drive-controls the DMD 36, whereby a correct image without distortion is finally obtained.

Next, as a fourth drawing position correcting portion, in this image forming device 10, the locus of each of the drawing pixel positions corresponding to the scanning positions is measured by a measuring device of the drawing pixel positions, and the locus data of each of the drawing pixel positions corresponding to the scanning positions are determined, for example, by executing an operation for scanning the moving stage 14, in a state where the measuring device (for example, a CCD with large area) of the drawing pixel positions having a two-dimensional measuring area is mounted on the moving stage 14, and a plurality of predetermined exposure beams lighted as the representative points in the exposure area 32 of the exposure head 26 are projected. The locus data of each of the drawing pixel positions corresponding to the scanning positions determined as mentioned above are stored in the scanning state table set in the memory region of the control unit 20 of the image forming device 10.

Further, in this image forming device 10, during the drawing operation, the control unit 20 executes correcting, on the basis of the locus data of each of the drawing pixel positions corresponding to the scanning positions which are read out from the scanning state table set in the memory region, so as to rectify the drawing distortion state or the displacement during the scanning, and drive-controls the DMD 36, whereby a correct image without distortion is finally obtained.

Next, a description will be given of a means for correcting digitally by an image or an allocating method to the image so as to inexpensively obtain an accurate predetermined drawing shape due to the image forming device 10 serving as a digital exposure device, on the basis of various data held in the memory of the control unit 20 relating to the locus of the drawing pixel positions or the like corresponding to the scanning positions of each of the drawing pixels, for correcting the distortion errors due to each of the respective exposure heads 26, and the position errors concomitant with the moving and scanning of the moving stage 14, as described in the first to fourth drawing position correcting portions mentioned above.

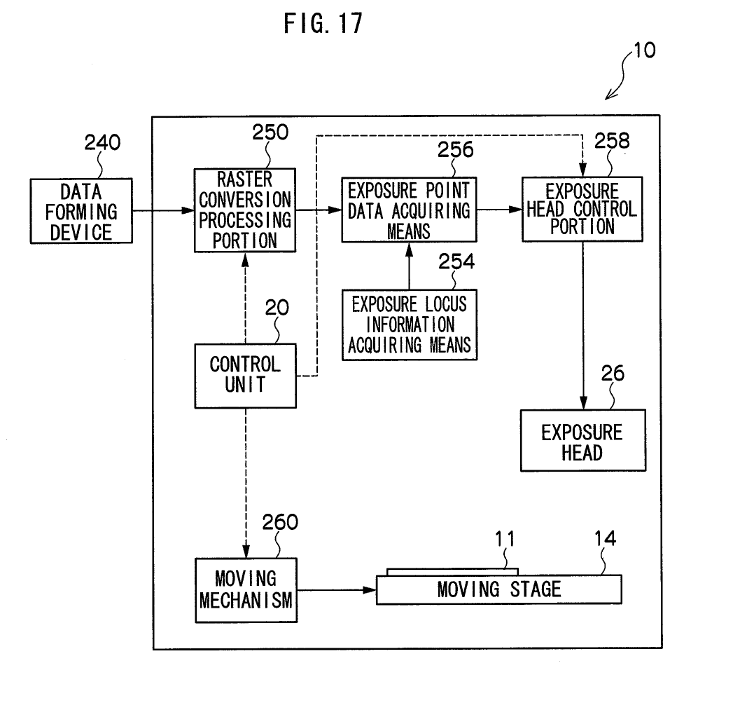

In this image forming device 10 it is possible, for example, to make corrections using a method called a beam tracking method. For example, in this image forming device 10, as shown in FIG. 17, there is provided a raster conversion processing portion 250 which receives vector data output from a data forming device 240 having a computer aided manufacturing (CAM) station and indicating an image (for example, a wiring pattern or the like) to be exposed, and converts the vector data into raster data (bitmap data), an exposure locus information acquiring portion 254 which acquires the information of the exposure locus of each of the micro mirrors 37 on the photosensitive material 11 at a time of an actual exposure, on the basis of various data relating to the locus of the drawing pixel positions corresponding to the scanning positions of each of the drawing pixels held in the memory of the control unit 20, an exposure point data acquiring portion 256 which acquires the exposure point data for each of the micro mirrors 37 on the basis of the exposure locus information of each of the micro mirror 37 acquired by the exposure locus information acquiring portion 254 and the exposure image data of the raster data output from the raster conversion processing portion 250, an exposure head control portion 258 which controls the exposure heads 26 so as to execute exposure by the DMDs 36 of the exposure heads 26 on the basis of the exposure point data of each the micro mirror 37 acquired by the exposure point data acquiring portion 256, a moving mechanism 260 which moves the moving stage 14 in a stage moving direction, and a controller 270 which controls the overall image forming device.

In this image forming device 10, during the drawing operation, firstly, the vector data indicating the drawing pattern to be exposed on the photosensitive material 11 is formed in the data forming device 240. Further, the vector data is input to the raster conversion processing portion 250, where the vector data is converted into the raster data and is output to the exposure point data acquiring portion 256, and is temporarily stored by the exposure point data acquiring portion 256.

When the vector data are input to the raster conversion processing portion 250 as mentioned above, the control unit 20 controlling the motions of the overall image forming device 10 outputs a control signal to the moving mechanism 260, and the moving mechanism 260 first moves the moving stage 14 to a predetermined initial position at an upstream side in the scanning direction along the guide 30 and thereafter moves toward a downstream side at a predetermined speed, according to the control signal.

Further, the exposure locus information acquiring portion 254 acquires the information of the exposure locus for each of the micro mirrors 37 on the photosensitive material 11 at a time of the actual exposure, on the basis of the various data relating to the locus of the drawing pixel positions or the like corresponding to the scanning positions of each of the drawing pixels held in the memory of the control unit 20.

Next, the exposure locus information determined for each of the micro mirrors 37 by the exposure locus information acquiring portion 254 is input to the exposure point data acquiring portion 256.

The exposure image data serving as the raster data is temporarily stored in the exposure point data acquiring portion 256, as mentioned above. The exposure point data acquiring portion 256 acquires the exposure point data for each of the micro mirrors 37 from the exposure image data on the basis of the input exposure locus information.

Further, a plurality of exposure point data are respectively acquired regarding each of the micro mirrors 37 in the exposure point data acquiring portion 256, in the same manner as mentioned above, and the exposure point data of each of the micro mirrors 37 are output to the exposure head control portion 258.

The moving stage 14 is returned again to the upstream side at a predetermined speed, and the exposure point data of each of the micro mirrors 37 are output to the exposure head control portion 258 as mentioned above.

When the position detecting sensor 24 (shown in FIG. 1) detects that the leading end of the photosensitive material 11 has come to the exposure starting position, exposure begins. Specifically, the control signal based on the exposure point data is output to the DMD 36 of each of the exposure heads 26 from the exposure head control portion 258, and the exposure heads 26 turn on and off the micro mirrors of the DMDs 36 on the basis of the input control signal so as to expose the photosensitive material 11.

The control signal is sequentially output to each of the exposure heads 26 concomitant with the movement of the moving stage 14, and the exposure is executed, and when a rear end of the photosensitive material 11 is detected by the position detecting sensor 24, exposure ends.

Further, in the image forming device 10, as a method of adjusting the image allocated to each of the drawing pixels from the locus data of the drawing pixel positions or the like, it is possible to execute correcting, for example, by a so-called data mapping method disclosed in JP-A No. 2003-57834, in addition to the means mentioned above. Further, in this image forming device 10, as the method of adjusting the image allocated to each of the drawing pixels from the locus data of the drawing pixel positions or the like, it is possible to execute correcting by a so-called image correction method of previously distorting the image to be drawn based on the proper image, such that the proper image may be exposed during actual exposure, in addition to the means mentioned above.

### [Operation Of Image Forming Device]

Next, a description will be given to an outline of operations of the image forming device 10 structured as mentioned above.

The light source unit 16 serving as a fiber array light source provided in the image forming device 10, while not illustrated, makes parallel the laser beams, such as ultraviolet rays or the like, emitted in a divergent beam state from each of laser light emitting devices by a collimator lens so as to converge by a connecting lens, inputs the beams from incident end surfaces of cores of multimode optical fibers so as to transmit the beams within the optical fibers, and multiplexes the beams into one laser beam by a laser emitting portion so as to emit the beam from the optical fiber 28 connected to the emitting end portions of the multimode optical fibers.

In this image forming device 10, the image data corresponding to the exposure pattern is input to the control unit 20 connected to the DMD 36, and is temporarily stored in the memory within the control unit 20. The image data is data indicating densities of each of the pixels which construct the image based on a binary system (whether a recording of a dot exists or not). The image data are properly corrected by a means for adjusting the image allocated to each of the drawing pixels or the like on the basis of the locus data of each of the drawing pixel positions corresponding to the scanning positions read out from the scanning state table which is set in the memory region by the control unit 20.

The moving stage 14 adsorbing the photosensitive material 11 to the surface thereof is moved at a constant speed from the upstream side to the downstream side in the feeding direction along the guides 30, by a driving device (not shown). When the leading end of the photosensitive material 11 is detected by the position detecting sensor 24 attached to the gate-shaped frame 22 at a time when the moving stage 14 passes beneath the gate-shaped frame 22, the corrected image data on the basis of the drawing distortion amount detected by the drawing distortion amount detecting portion stored in the memory is sequentially read out for each of plural lines, and the control signal is generated for each of the exposure heads 26 on the basis of the corrected image data read out by the control device serving as the data processing portion.

Further, in the image forming device 10, each of the micro mirrors of the spatial light modulating element (DMD) 36 is on/off controlled for each of the exposure heads 26 on the basis of the generated control signal.

When the laser light is irradiated to the spatial light modulating element (DMD) 36 from the light source unit 16, the laser light reflected at a time when the micro mirror of the DMD 36 is in the ON state is imaged at the exposure position for the properly corrected drawing. Due to this, the laser light emitted from the light source unit 16 is turned on or off for each pixel, and the photosensitive material 11 is exposed.

Further, the photosensitive material 11 is moved at a constant speed together with the moving stage 14, whereby the photosensitive material 11 is scanned in an opposite direction to the stage moving direction by the exposure head unit 18, and the band-shaped exposed regions 34 (illustrated in FIG. 2) are formed for each of the exposure heads 26.

When the scanning of the photosensitive material 11 by the exposure head unit 18 is finished, and the rear end of the photosensitive material 11 is detected by the position detecting sensor 24, the moving stage 14 is returned to the starting point at the most upstream side in the feeding direction along the guides 30 by the driving device (not shown), and is again moved at the constant speed from the upstream side to the downstream side in the feeding direction along the guides 30.

Further, in the image forming device 10 in accordance with the present embodiment, the DMD is used as the spatial light modulating element used in the exposure head 26, however, it is possible to use, for example, micro electro mechanical systems (MEMS)-type special light modulators (SLM) and other types of spatial light modulating elements than the MEMS type such as an optical element (a PLZT element) modulating a transmitted light on the basis of an electro-optical effect or a liquid crystal light shutter (FLC) or the like, in place of the DMD. Further, it is possible to use a spatial light modulating element which can express a gradation.

Note that the MEMS is a generic term of a micro sized sensor due to a micromachining technology based on an IC manufacturing process, an actuator, and a minute system in which a control circuit is integrated, and the MEMS type spatial light modulating element means a spatial light modulating element driven by an electromechanical operation utilizing an electrostatic force.

Further, in the image forming device 10 in accordance with the present embodiment, the spatial light modulating element (DMD) 14 used in the exposure head 26 may be replaced by a means for selectively turning on and off a plurality of pixels (a device for selectively modulating a plurality of pixels). The means for selectively turning on and off the plurality of pixels can include a laser light source which selectively turns on and off the laser beams corresponding to each of the pixels so as to be capable of emitting the beams, or can include a laser light source which forms a surface emitting laser element by arranging each of minute laser emitting surfaces corresponding to each of the pixels and selectively turning on and off each of the minute laser emitting surfaces so as to be capable of emitting light.

Further, in the image forming device 10 configured as the exposure device in accordance with the embodiment mentioned above, a description is given of the configuration for radiating the exposure beam from the exposure head unit 18 fixed to the predetermined position and executing the exposing process while moving the moving stage 14 on which the photosensitive material is mounted; however, the exposure beam may also be radiated so as to execute the exposing process while moving the exposure head unit 18, or while moving the exposure head unit 18 as well as moving the moving stage 14 on which the photosensitive material is mounted.

In this case, a relative positional relation between the stage and the exposure heads is detected by a moving position detecting portion utilizing generally used sensors or the like which are capable of detecting relative positional relations.

In this case, it is obvious that the exposure device in accordance with the present invention is not limited to the embodiment mentioned above, but can employ other various structures within the scope of the invention.

### INDUSTRIAL APPLICABILITY

The exposure device can be applied to a digital exposure device or the like executing the image exposure on the exposure member by the light beams modulated corresponding to the image data, and can form high-quality exposed images by correcting the drawing pixel positions so as to execute the drawing with high precision.

### DESCRIPTION OF REFERENCE NUMERALS

10 mage forming device

11 photosensitive material

14 moving stage

18 exposure head unit

20 control unit

24 position detecting sensor

26 exposure head

32 exposure area

37 micro mirror

37 micro mirror

48 exposure beam

48A pixel

70 slit plate

72 photo sensor

74 detecting slit

76 Linear encoder P 78 scale plate

80 optical transmitter

82 optical receiver

102 mirror member

104 laser beam distance measuring device

106 laser beam distance measuring device

108 mirror member

110 laser beam distance measuring device

What is claimed is:

1. An exposure device, comprising:
an exposure head executing an exposure with a predetermined pattern by relatively moving a stage and the exposure head while respective light beams, emitted from a device disposed in the exposure head that selectively modulates on the basis of image data a plurality of drawing pixels, are radiated on an exposure member mounted on the stage;
a control unit storing in a memory at least correcting data relating to a locus of drawing pixel positions corresponding to scanning positions of predetermined drawing pixels necessary for correction; and
a drawing position correcting portion obtaining a predetermined drawing shape by adjusting an image allocated to each of the drawing pixels on the basis of the correcting data stored in the control unit.

2. An exposure device, comprising:
an exposure head executing an exposure with a predetermined pattern by relatively moving a stage and the exposure head while respective light beams, emitted from a device disposed in the exposure head that selectively modulates on the basis of image data a plurality of drawing pixels, are radiated on an exposure member mounted on the stage;
a beam position detecting portion for detecting at least positions of predetermined drawing pixels necessary for correction, which are radiated on the exposure member on the stage from the exposure heads;
a moving position detecting portion detecting a relative positional relation between the stage and the exposure head when the stage and the exposure head are moved relatively;
a control unit storing in a memory at least correcting data relating to a locus of drawing pixel positions corresponding to scanning positions of the predetermined drawing pixels at least necessary for correction, which are obtained from detected data by the beam position detecting portion and detected data by the moving position detecting portion; and
a drawing position correcting portion obtaining a predetermined drawing shape by adjusting an image which is allocated to each of the drawing pixels on the basis of the correcting date stored in the control unit.

3. An exposure device, comprising:
an exposure head executing an exposure with a predetermined pattern by relatively moving a stage and the exposure head in a state while respective light beams, emitted from a device disposed in the exposure head that selectively modulates a plurality of drawing pixels on the basis of image data, are radiated on an exposure member mounted on the stage;
a beam position detecting portion detecting at least positions of predetermined drawing pixels necessary for correction, which are radiated on the exposure member on the stage from the exposure heads, and determining a single drawing distortion state within an exposure area;
a moving position detecting portion detecting vector data when relatively scanning and moving the stage and the exposure head;
a control unit storing in a memory at least correcting data relating to a locus of drawing pixel positions corresponding to scanning positions of the predetermined drawing pixels necessary for correction, the data being obtained from the single distortion state by the beam position detecting portion and the vector data during the scanning and moving detected by the position detecting portion; and
a drawing position correcting portion obtaining a predetermined drawing shape by adjusting an image which is allocated to each of the drawing pixels on the basis of the correcting data stored in the control unit.

4. An exposure device, comprising:
an exposure head executing an exposure with a predetermined pattern by relatively moving a stage and the exposure head while respective light beams, emitted from a device disposed in the exposure head for selectively modulating on the basis of image data a plurality of drawing pixels, are radiated on an exposure member mounted on the stage;
a control unit forming an image obtained by drawing a locus of each of drawing pixel positions by relatively moving and scanning the stage and the exposure head, where a drawn medium is mounted on the stage and the pixels are exposed by a predetermined plurality of exposure beams, which are lit as representative points in an exposure area of the exposure head, measuring the locus of each of the drawing pixel positions drawn on the drawn medium, determining locus data of each of the drawing pixel positions corresponding to scanning positions, and storing the determined locus data of each of the drawing pixel positions corresponding to the scanning positions in a memory; and
a drawing position correcting portion obtaining a predetermined drawing shape by adjusting an image which is allocated to each of the drawing pixels on the basis of the locus data stored in the control unit.

5. An exposure device comprising:
an exposure head executing an exposure with a predetermined pattern by relatively moving a stage and the exposure head while respective light beams, emitted from a device disposed in the exposure head for selectively modulating on the basis of image data a plurality of drawing pixels, are radiated on an exposure member mounted on the stage;
a control unit measuring a locus of each of drawing pixel positions corresponding to scanning positions by a drawing pixel position measuring device, by relatively moving and scanning the stage and the exposure head, where the drawing pixel position measuring device, having a two-dimensional measurement area, is mounted on the stage, and the pixels are exposed by a predetermined plurality of exposure beams which are lit as representative points in an exposure area of the exposure head, and determining locus data of each of the drawing pixel positions corresponding to the scanning positions, and storing the determined locus data of each of the drawing pixel positions corresponding to the scanning positions in a memory; and
a drawing position correcting portion obtaining a predetermined drawing shape by adjusting an image which is allocated to each of the drawing pixels on the basis of the locus data stored in the control unit.

6. The exposure device of claim 1, wherein the device for modulating includes a digital micro mirror device.

7. The exposure device of claim 2, wherein the beam position detecting portion includes a slit plate and a light detecting device attached to an end edge portion at an upstream side in a scanning direction of the stage, and the moving position detecting portion includes a linear encoder.

8. The exposure device of claim 7, wherein the moving position detecting portion is arranged corresponding to one side surface along the scanning direction of the stage, and a side surface at a rear end in the scanning direction.

9. The exposure device of claim 8, wherein the moving position detecting portion includes a mirror member for reflecting the laser beam, and laser beam distance measuring devices spaced at a predetermined intervals so as to oppose the mirror member.
